(19) United States
(12) Patent Application Publication
(10) Pub. No.: US 2009/0129788 A1
(43) Pub. Date: May 21, 2009

(54) Optical Receiver For Receiving A Signal With M-Valued Quadrature Amplitude Modulation With Differential Phase Coding And Application Of Same

(76) Inventor: Matthias Seimetz, Berlin (DE)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 12/344,835

(22) Filed: Dec. 29, 2008

Related U.S. Application Data
(63) Continuation of application No. PCT/EP2007/005549, filed on Jun. 23, 2007.

(30) Foreign Application Priority Data
Jun. 29, 2006 (DE) DE102006030915.4

(51) Int. Cl. H04B 10/06

(52) U.S. Cl. 398/208

(57) ABSTRACT

Optical data signal receiver having an optical separation of the received data signal into two signal paths, namely, an amplitude detection path and a phase detection path, wherein the phase detection path is split into an in-phase signal path generating in-phase-signals and a quadrature-signal path generating quadrature-signals, and both the in-phase-signal path and the quadrature-signal path, as well as the amplitude detection path, are connected to an analysis unit for demodulation of the received data signal, in which a normalizer and thereafter a symbol discriminator and a data reconstruction logic are arranged in the analysis unit. In the receiver, a connection is provided at least from the amplitude detection path to the normalizer, the normalizer normalizing the in-phase and quadrature-signals with the aid of the signal output from the amplitude detection path, the symbol discriminator discriminating the symbols output from the normalized in-phase and quadrature-signals. Additional connections can be provided from the amplitude detection path signal.

### CROSS-REFERENCE TO RELATED APPLICATION

This application is a continuation of application PCT/EP2007/005549 filed 23 Jun. 2007.

### BACKGROUND

The invention relates to an optical receiver for receiving an optical data signal which, through application of M-valued quadrature amplitude modulation (QAM) with differential phase coding, comprises individual symbols having the length of the symbol duration and contains an item of amplitude information and an item of differential phase information, comprising an optical splitting of the received data signal between two signal paths, of which one is embodied as an amplitude detection path and the other is embodied as a phase detection path, wherein the phase detection path is split into an in-phase signal path for generating in-phase signals and a quadrature signal path for generating quadrature signals, and in-phase signal path and quadrature signal path and also amplitude detection path are connected to an evaluation unit for the demodulation of the received data signal, and to applications of the receiver.

In modern optical transmission technology, complex, higher-valued modulation methods are employed for efficient utilization of the optical bandwidth and for improvement of the transmission properties. In this case, symbols code a specific number of bits and allocate a specific amplitude and phase to the optical carrier. In the case of M-valued differential phase modulation (M-DPSK), all the symbols lie on one and the same constellation circle (M symbols having one (A) amplitude state and P phase states). In the case of M-valued quadrature amplitude modulation (QAM) with differential phase coding, by contrast, not only a plurality (P) of phase states but also different amplitudes exist, such that the symbols are distributed among a plurality of constellation circles that are concentric with respect to the origin. In order to enable an asynchronous differential demodulation at the receiver end, in both cases at the transmitting end the phase has to be coded differentially by an encoder, such that the phase information is contained in the difference between two successive phase states in the data signal. A 16QAM can define for example 16 symbols with P=8 different phase states and two different amplitude states A=2. M-valued QAM signals with differential phase shift keying can be transmitted for example in optical access, metropolitan and wide area networks.

### PRIOR ART

The standard method for data transmission in optical networks is intensity modulation or else OOK (on-off keying), wherein only the intensity of the light is modulated as an optical data carrier or light is switched on and off. In recent years, however, there has been growing interest in alternative modulation formats for optical transmission, firstly in order to increase the spectral efficiency of the transmission, and secondly in order to be able to utilize the in some instances better transmission properties of alternative methods.

Thus, a few years ago, by way of example, differential binary phase modulation (DBPSK) was proposed in publication I by M. Rohde et al.: “Robustness of DPSK direct detection transmission format in standard fiber WDM systems” (in Electronic Letters, vol. 36, pp. 1483-1484, 1999) as an interesting alternative to OOK with improved tolerance toward fiber nonlinearities. The use of an optical delay interferometer (DLI) in this case makes it possible to convert the differentially coded phase information of the optical wave into an intensity modulation before the photodiode detection and thus to directly detect the phase-modulated optical signal without the use of a coherent receiver. Increasingly higher-valued modulation formats were then employed in the following years. The use of two DLIs having different phase delays makes it possible to detect the in-phase and quadrature components of optical data signals with higher-valued phase modulation. In the case of 4-valued (M=P=4) differentially coded phase modulation (DQPSK), this reception method leads to binary electrical signals in the in-phase and quadrature signal path. In the case of 8-valued DPSK (M=P=8), a structure with four DLIs and binary electrical signals or else a structure with two DLIs and multi-step electrical signals is possible.

By realizing an additional arm for intensity detection, it is also possible to detect QAM signals with differential phase coding, but this has only been shown for formats with a maximum of four phase states (P=4). Thus, by way of example, the reception of ASK-DQPSK (or else 8-QAM) is described in publication II by M. Ohm and J. Speidel: “Receiver sensitivity, chromatic dispersion tolerance and optimal receiver bandwidths for 40 Gbit/s 8-level optical ASK-DQPSK and optical 8-DPSK” (in Proc. 6th Conference on Photonic Networks, Leipzig, Germany, May 2005, pp. 211-217) and the reception of so-called 16-APSK signals (16-valued amplitude and phase modulation) with in each case four amplitude and phase states (P=4) is described in publication III by K. Sekine et al.: “Proposal and Demonstration of 10-Gsymbol/sec 16-ary (40 Gbit/s) Optical Modulation/Demodulation Scheme” (in Proc. ECOC 2004, paper We3.4.5, 2004). The present invention proceeds from this document, which describes optical direct reception for the heretofore highest-valued quadrature amplitude modulation (QAM), as the closest prior art. This document discloses an optical receiver for receiving an optical data signal which, through application of a 16-valued, quadrature amplitude modulation with differential phase coding, comprises individual symbols having the length of the symbol duration and contains an item of amplitude information and an item of differential phase information, wherein four amplitude states and four phase states (P=4) are defined here. In this case, the received data signal is optically split between two signal paths. One signal path is embodied as an amplitude detection path and the other as a phase detection path. Furthermore, the phase detection path is also optically split into an in-phase signal path for generating in-phase signals and a quadrature signal path for generating quadrature signals. Both paths lead to an electrical evaluation unit for the reconstruction of the received data signal.

Furthermore, publication IV by P.S. Cho et al.: “Investigation of 2-b/s/Hz 40-Gb/s DWDM Transmission Over 4×100 km SMF-28 Fiber Using RZ-DQPSK and Polarization Multiplexing” (in IEEE Photonic Technology. Letters, vol. 16, No. 2, pp. 656-658, 2004) showed that for the conversion of the differentially coded phase information in an intensity modulation, instead of two DLIs it is also possible to use a 2×4-90° hybrid, wherein the non-delayed optical data signal is fed into one input of the hybrid and the optical data signal delayed by a symbol time is fed into the other input of the hybrid. It is evident from this that optical direct reception can also be interpreted as “self-coherent reception” of the data signal with its delayed copy.

The same principle is also used by the receiver described in publication V by A. Meijerink et al.: “Balanced Optical Phase Diversity Receivers for Coherence Multiplexing” (in J. of Lightwave Technol., vol. 22, No. 11, pp. 2393-2408, 2004) for the reception of M-DPSK-modulated coherence multiplex signals.

One alternative to optical direct reception is optical coherent reception. This reception principle involves superposing the signal light with the light from a local laser (local oscillator) before the detection by the photodiode. In this way it is possible to transfer all data-relevant information of the optical light wave (amplitude, frequency, phase and polarization) into the electrical domain. By maintaining it, coherent reception is very well suited to the reception of optical signals with higher-valued modulation. Furthermore, coherent reception affords the advantage that compensation of the chromatic dispersion by linear electrical filtering is possible and electrical channel separation can be performed by low-pass filtering during the reception of optical wavelength division multiplex (WDM) signals. What proved to be difficult, on the other hand, in a coherent reception are the frequency synchronization of signal and local lasers (controllable for example by an automatic frequency control loop), the control of the polarization (handleable by the polarization diversity method) and also the phase noise.

Coherent reception offers two variants, in principle. In heterodyne reception, the frequencies of the signal and local lasers do not correspond, and the signal is converted to an electrical intermediate frequency. The reception of higher-valued optical PSK and DPSK and also of QAM signals is possible here when an electrical phase locked loop is used. Heterodyne reception has disadvantages, however, in WDM and at high data rates since the components required have to operate at very high frequencies. Therefore, in recent years interest has been focusing on optical homodyne reception. Here the frequencies of signal and local lasers ideally exactly correspond and the information of the optical signal is converted directly to electrical baseband. The phase noise can be controlled here by means of an optical phase locked loop (OPLL), as is likewise described in publication III. A further possibility, which makes it possible to receive any desired QAM signals and has recently become available owing to the presence of digital high-speed signal processing, is compensation of the phase noise by using a module for digital phase estimation. This variant is described for example in publication VI by M. Seimetz: “Performance of Coherent Optical Square-16-QAM-Systems based on IQ-Transmitters and Homodyne Receivers with Digital Phase Estimation” (in Proc. NFOEC 2006, paper NWA4).

A further reception possibility is afforded by phase diversity homodyne reception. Here the phase noise is elegantly compensated for by a specific electrical network. About 15-20 years ago this method was intensively investigated for binary modulation formats (binary amplitude shift keying 2-ASK, binary frequency shift keying 2-FSK, binary differential phase shift keying 2-DPSK). For 2-ASK, squaring in the in-phase and quadrature signal path with subsequent addition of the two squared signals suffices for compensation of the phase noise. In 2-DPSK, the compensation is achieved by means of an electrical self-multiplication of the in-phase and quadrature signals by their copies delayed by a symbol time, and a subsequent addition. The phase diversity principle was taken up and extended in publication V (already cited above) in connection with optical systems with coherence multiplexing, wherein an electrical compensation network for M-valued DPSK methods was presented here which was used, however, within a self-homodyne receiver for the possible reception of coherence multiplex signals.

### STATEMENT OF PROBLEM

The problem addressed by the present invention can be considered that of providing a structure for a generic receiver of the type mentioned in the introduction which makes it possible to receive any desired differentially phase-coded QAM data signals. In particular, the intention is to be able to detect QAM data signals even if the number of phase states is greater than 4 (P>4). In this case, the reception principle according to the invention is intended to be universally useable such that it can be applied not only to optical direct reception but also to optical phase diversity coherent reception.

The solution to this problem consists in an optical receiver explained in more detail below in connection with the invention. In particular, it will be clarified below that phase diversity homodyne reception can also be expanded to the reception of QAM signals with differential phase coding by providing a parallel path for intensity detection. For this purpose, it is necessary firstly to establish that the output signals of the electrical compensation network, given the presence of a plurality of amplitude states, actually still supply usable information for detection of the differential phase information.

According to the invention, the optical receiver is characterized by

1. An arrangement of a normalizer and thereafter a symbol decision unit and a data reconstruction logic in the electrical evaluation unit, and either
1.1. a connection of the amplitude detection path both to the normalizer and to the symbol decision unit, wherein, in the normalizer, the in-phase and quadrature signals are divided by the present amplitude information of the received data signal and the amplitude information thereof delayed by the symbol duration and, in the symbol decision unit, the symbol decisions are made by amplitude decision and by in-phase/quadrature phase decision, or
1.2. a connection of the amplitude detection path at least to the normalizer, wherein, in the normalizer, the in-phase and quadrature signals are divided only by the amplitude information delayed by the symbol duration and, in the symbol decision unit, the symbol decisions are made by means of an in-phase/quadrature decision or an amplitude/phase decision on the basis of the reconstructed QAM constellation, or
2. an arrangement of an ARG operator and thereafter a symbol decision unit and a data reconstruction logic in the electrical evaluation unit and a connection of the amplitude detection path at least to the symbol decision unit, wherein, in the ARG operator, an angle determination of the in-phase and quadrature signals is carried out and, in the symbol decision unit, the symbol decisions are made by amplitude decision and by phase decision from the output signal of the ARG operator.

The invention is therefore fundamentally characterized in that a further component is additionally arranged alongside a symbol decision unit and a data reconstruction logic in the electrical evaluation unit. This is either a normalizer or an ARG operator. With the normalizer, symbols lying on different circles can be normalized on to a common constellation circle. Afterward, for detecting the phase information in the symbol decision unit it is only necessary to make a simple symbol decision as in the case of DPSK formats. For this type of processing, it is necessary for the amplitude path to be coupled both to the normalizer and to the symbol decision unit. If only a connection of the amplitude detection path to the normalizer is provided, an in-phase/quadrature decision or an amplitude/phase decision can be made in the symbol decision unit even without direct knowledge of the amplitude information. When the amplitude path is connected only to the symbol decision unit, an ARG operator is used instead of the normalizer, said ARG operator determining the angular position of the in-phase and quadrature signals. In both cases, however, the amplitude path can also be connected to the respective other component in order to simplify and improve the method.

The stated measures in the electrical evaluation unit make possible the reception of data signals modulated in higher-valued fashion as desired with M-valued quadrature amplitude modulation with differential phase coding in principle for different optical receivers.

Firstly, an embodiment of the optical receiver as a direct receiver is advantageously possible, in which case an amplitude detection path and also a phase detection path based on direct reception are then provided. The PM-IM conversion in the phase detection path, wherein the differential phase modulation PM is converted into an intensity modulation IM, which can then be detected by the differential signal detectors, can be realized either with delay interferometers (DLI) or else with the aid of a 2×4 90° hybrid and a unit for symbol delay by the length of a symbol duration upstream of one of the hybrid inputs. Two downstream differential signal detectors then supply the in-phase and quadrature signals, which are then processed further by the processing described in the optical receiver according to the invention. Furthermore, an optical phase shifter can advantageously also additionally be provided upstream of one of the hybrid inputs, by means of which phase shifter the received constellation diagram can then be rotated as desired.

Secondly, an optical receiver according to the invention can likewise be embodied as a phase diversity coherent receiver by arranging a 2×4-90° hybrid in the phase detection path with a local oscillator and one of the two hybrid inputs. Furthermore, a downstream arrangement of a respective differential signal detector and a low-pass filter at in each case two outputs of the 2×4-90° hybrid is provided. That is followed by an arrangement of an electronic network in which the received in-phase signal is freed of the phase noise by a self-multiplication of the in-phase signal and quadrature signal with their copies delayed by the symbol duration and a subsequent addition and the received quadrature signal is freed of the phase noise by a cross-multiplication of the in-phase signal and quadrature signal by their copies delayed by the symbol duration and a subsequent subtraction.

Further modifications known per se from the prior art are then possible for both receiver embodiments.

Firstly, however, the invention will be described for enabling the optical direct reception of QAM data signals with as many phase states as desired.

If, for the phase detection path, the detected in-phase and quadrature photocurrents are calculated at the output of the two differential receivers (the known DLI structure or else the 2×4-90° hybrid structure can be used previously), and the following result is produced, represented in a simplified manner:

I(t)˜\sqrt{√Pₛ(t)Pₛ(t−Tₛ)}cos [Δφ(t)] (1)

Q(t)˜\sqrt{Pₛ(t)Pₛ(t−Tₛ)}sin [Δφ(t)] (2)

In equations (1) and (2), Pₛ(t) represents the optical signal power at the instant t, Pₛ(t-Tₛ) is the power of the optical signal delayed by a symbol duration, and Δφ(t) is the differential phase of two successive symbols. The detected in-phase and quadrature photocurrents I(t), Q(t) are thus proportional to the present amplitude and the amplitude delayed by a symbol duration and the present differential phase.

Previously disclosed optical direct receivers for QAM with up to four phase states arrive at a recovery of the amplitude and differential phase information in the following way: the amplitude is detected via a separate path. By correspondingly setting the phase differences in the DLIs or corresponding setting the relative phase between the two inputs of the 2×4 90° hybrid, the constellation diagram is rotated by 45°. The resulting differential phases are detected by threshold decisions at zero for evaluation of the in-phase and quadrature photocurrents. This method suffices with the presence of just four differential phases (45°, 135°, 225°, 315°). Threshold decisions at zero then yield an unambiguous recovery of the data information (450: S_{I}=1, S_{Q}=1, 135°: S_{I}=0, S_{Q}=1, 225°: S_{I}=0, S_{Q}=0, 315°: S_{I} 1, S_{Q}=0 where S_{I} represents the decision in the in-phase signal path and S_{Q} represents the decision in the quadrature signal path). This becomes clear if the differential phases are inserted into equations (1) and (2) and the decision is then carried out in the in-phase and quadrature signal. In the case of just four differential phases, therefore, only the polarity of the in-phase and quadrature signals is important and any values of the present and delayed amplitude, the product of which is positive in any case, permit a detection of the differential phase for decision threshold at zero.

When more than four differential phases are present, the evaluation of the in-phase and quadrature signals can no longer be carried out by means of a single threshold at zero per signal, rather a plurality of thresholds per signal are then necessary for recovering the information. Moreover, said thresholds are no longer at zero. However, since the in-phase and quadrature signals are determined by a mix of information (the present amplitude and the previous amplitude and also the differential phase), see equation (1) and (2), it is no longer possible to recover the information with fixed thresholds without additional measures. Therefore, in the optical receiver according to the invention, a normalization of the photocurrents are performed in a normalizer.

In a first alternative of the invention, the normalization consists in a division of the detected photocurrents by the present amplitude and the amplitude delayed by a symbol duration, such that all the symbols then lie on a single constellation circle. For this purpose, the amplitude information available from the amplitude detection path is used. After the normalization, the differential phase information can be recovered without any problems by means of a standard IQ decision as in the case of the pure DPSK formats. The amplitude information is available anyway by means of a decision of the data signal from the amplitude detection path.

In a second alternative of the invention, the normalization consists only in a division of the detected photocurrents by the delayed amplitude. By this means, the undesired factor of the delayed amplitude in equation (1) and (2) is eliminated and the original constellation diagram of the QAM is available for a standard QAM decision. The data signal from the amplitude detection path is once again used for the normalization, which in this case, however, does not have to be used directly for the amplitude decision.

In the third alternative, which does not use a normalizer, the amplitude information is decided via the amplitude detection path. The information of the differential phase can be determined from the in-phase and quadrature signals—independently of the amplitude path—by carrying out an ARG operation wherein the angle is determined from real and imaginary parts of a complex number. This can be realized with the aid of digital signal processing.

The three new variants claimed, by means of which, in the case of a direct receiver, the optical direct reception can be expanded to the detection of QAM signals with as many phase states as desired, can, however, also be applied to a coherent receiver, in particular for phase diversity homodyne reception. This type of receiver has previously been known in the prior art only for M-valued DPSK without an additional amplitude detection path and for any higher-valued DPSK also only in connection with self-homodyne reception. It will now be shown hereinafter that, by providing the same components as in a direct receiver, it is also possible to enhance a coherent receiver for higher-valued QAM.

The prior art discloses phase diversity homodyne reception and/or binary modulation methods and self-homodyne reception also for higher-valued DPSK methods. In the phase diversity coherent receiver for QAM with differential phase coding as claimed by the invention, for the first time—as in a direct receiver for QAM—an amplitude detection path is likewise made available for detecting the intensity of the received data signal by means of a coupler. Via the parallel phase detection path, the received data signal is fed into a 2×4-90° hybrid, where it is superposed with the signal from a local laser (LO). The outputs of the hybrid are detected by two differential receivers. The resulting in-phase and quadrature signals can be described—represented in a simplified manner—by the following equations:

I*(t)˜\sqrt{Pₛ(t)P_{LO}}cos [Δωt+φ(t)+Δφ_{N}(t)] (3)

Q*(t)˜\sqrt{Pₛ(t)P_{LO}}sin [Δωt+φ(t)+Δ_{N}(t)] (4).

In equations (3) and (4), Pₛ(t) once again represents the optical signal power at the instant t, P_{LO}(t) is the power of the local laser at the t, Δω is the frequency deviation of signal and local lasers, φ(t) represents modulation phase, and Δφ_{N}(t) describes an additional, temporally variable phase offset caused by a zero phase deviation of signal and LO and by the phase noise. This undesired phase offset is eliminated using an electronic network such as has already been presented in publication V. Upon calculating the entire structure, assuming exact frequency synchronization at the outputs of the electronic network, the following photocurrents freed of the phase noise are produced—represented in a simplified manner:

I(t)˜\sqrt{Pₛ(t)P_{S}(t−Tₛ)}P_{LO} cos [Δφ(t)] (5)

Q(t)˜\sqrt{Pₛ(t)P_{S}(t−Tₛ)}P_{LO} sin [Δφ(t)] (6).

As in equations (1) and (2), here as well Δφ(t) is the present modulation differential phase of two successive symbols. The result, which is a surprising result since it is in no way inevitable or self-evident, and is at the same time highly gratifying, is that equations (5) and (6)—apart from the constant and undisturbing term of the local laser power—correspond to equations (1) and (2) in direct reception. The detected in-phase and quadrature photocurrents freed of the phase noise, after passing through the electronic network, as in direct reception, are thus proportional to the present amplitude and the amplitude delayed by a symbol duration and also the present differential phase. Consequently, here the same structural concepts for recovering amplitude and differential phase information can be employed as already proposed previously in the case of the direct receiver.

In the first alternative, the amplitude is detected via the amplitude detection path and the additional information is simultaneously used for normalization on to a constellation circle, whereupon the differential phase information can subsequently also be determined by means of IQ decision as in the case of DPSK. In the second alternative, the information from the amplitude detection path is used for normalization by carrying out a division by the delayed amplitude and then an IQ decision or amplitude/phase decision is subsequently carried out with regard to the received QAM constellation. The third alternative uses the amplitude detection path for direct amplitude detection and determines the differential phase by carrying out an ARG operation.

In the case of the direct amplitude decision via the amplitude detection path it may additionally be advantageous likewise to detect the amplitude by means of a coherent reception method. This is claimed in a further embodiment.

Both for the direct receiver and for the phase diversity homodyne receiver it is furthermore advantageous to integrate the 2×4-90° hybrid as a multimode interference (MMI) coupler together with the two differential receivers on one chip. For the optical direct receiver, it is likewise possible to concomitantly integrate the input-side 3 dB coupler and also the symbol delay upstream of one of the hybrid inputs and furthermore a phase shifter upstream of one of the hybrid inputs. This additional phase shift makes it possible to rotate the received constellation diagram as desired and thus to realize different decision mechanisms.

If the use of a 2×4 90° hybrid is to be avoided in the phase diversity receiver, a three-arm configuration using a 3×3 coupler is also possible, in principle, in a further embodiment. The in-phase and quadrature signals can then be formed by means of adequate electrical processing, as also known from publication V.

The possible use of the phase diversity homodyne receiver according to the invention as a WDM receiver constitutes a particular advantage of the invention. A desired channel can be selected by tuning the local laser to the frequency of the desired channel and low-pass filtering of the detected in-phase and quadrature photocurrents. Since the channel separation is effected by electrical filtering, a high selectivity can be obtained in this case. Optical filters for channel selection such as have to be used in direct reception can be completely dispensed with. It is likewise advantageous that a module for electronic dispersion compensation can optionally be provided, which can be used to achieve a compensation of the chromatic dispersion which is theoretically ideal but in practice is limited in performance by the design of the filters. In this case, maintaining the temporal phase information is a particular advantage in comparison with direct reception.

The electronic network for compensation of the phase noise in the phase diversity receiver according to the invention can be realized, in principle, with analog components or else with digital signal processing. In the case of homodyne reception, care should likewise be taken here to ensure corresponding frequencies of signal and local lasers. Deviations lead to a loss of performance. The frequency equality must therefore possibly be guaranteed by additional outlay. For this purpose it is possible to use for example an automatic frequency control loop (AFC loop) or else a digital estimation of the frequency deviation.

A further advantage of the receiver proposed by the invention is that the entire receiver structure through to the decision units, for the same symbol rate, has a construction independent of the modulation format. This makes the use of the receivers in adaptive systems conceivable, wherein different modulation formats can be realized by sole adaptation of the concluding decision unit electronics and also data reconstruction logic. Both the modular replacement of modulation-specific electronic modules and the parallel design for different modulation formats by means of arrays of electronic modules are conceivable.

Future investigations will show which modulation formats can be used particularly expediently in which network segments. The flexibility of the receiver proposed by the invention with regard to the modulation formats permits use in optical wide area, metropolitan and access networks.

### BRIEF DESCRIPTION OF THE DRAWINGS

For a further understanding of the optical receiver according to the invention for receiving an optical data signal which, through application of M-valued quadrature amplitude modulation with differential phase coding, comprises individual symbols having the length of the symbol duration and contains an item of amplitude information and an item of differential phase information, individual embodiments are explained by way of example below with reference to the schematic figures, in which

FIG. 1 shows from the prior art: a constellation diagram of a 16-QAM with eight phase states,

FIG. 2 shows an embodiment as an optical direct receiver (configuration with two DLIs) with a normalization on to a constellation circle and an IQ decision of the phase information,

FIG. 3 shows an embodiment as an optical direct receiver (configuration with 2×4 90° hybrid and additional phase shifter upstream of one of the hybrid inputs) with a normalization on to a constellation circle and an IQ decision of the phase information,

FIG. 4 shows an embodiment as an optical direct receiver with a simple normalization and also a decision of the reconstructed QAM constellation with the use of the structure with a 2×4 90° hybrid,

FIG. 5 shows an embodiment as an optical direct receiver and a determination of the phase information and for carrying out an ARG operation with the use of the structure with a 2×4 90° hybrid,

FIG. 6 shows an embodiment as a phase diversity homodyne receiver with a normalization on to a constellation circle and an IQ decision of the phase information,

FIG. 7 shows an embodiment as a phase diversity homodyne receiver with a simple normalization and a decision of the reconstructed QAM constellation, and

FIG. 8 shows an embodiment as a phase diversity homodyne receiver with a determination of the phase information after carrying out an ARG operation.

### DESCRIPTION OF EXEMPLARY EMBODIMENTS

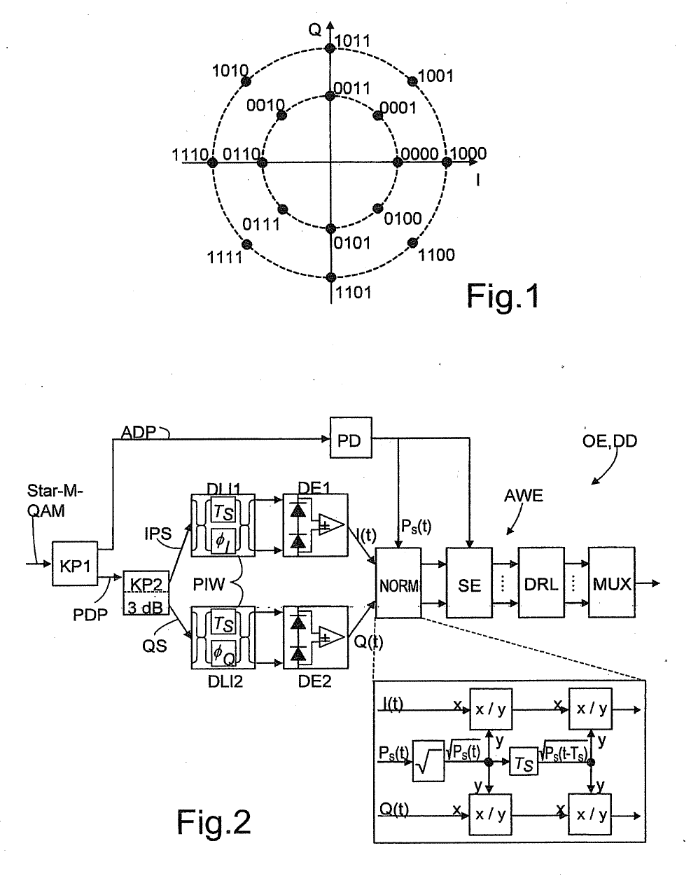

FIG. 1 shows a constellation diagram of a 16QAM with eight phase states. Data signals coded by such a higher-valued modulation method (M=number of symbols=8) can readily be received and decoded without any problems for the first time by means of the optical receiver according to the invention.

FIG. 2 shows the optical receiver OE according to the invention in the embodiment of an optical direct receiver DD. The received data signal Star-M QAM is split between an amplitude detection path ADP and a phase detection path PDP by means of a first optical coupler KP1. The amplitude detection path ADP contains a photodiode PD, which detects the incoming optical data signal and converts the amplitude or intensity thereof into a corresponding electric current. Arranged in the phase detection path PDP is a second optical coupler KP2 (with a uniform 3 dB signal splitting in the exemplary embodiment shown), which splits the received data signal between an in-phase signal path IPS and a quadrature signal path QS. In each case a delay interferometer DLI1, DLI2 as PM-IM converter PIW and a differential signal detectors DE1, DE2 are arranged in series in both paths. In the case of the delay interferometers DLI1, DLI2, only one input but both outputs are used. The delay by the symbol duration Tₛ is set in one path of DLI1, DLI2, and the phase shift of the in-phase signal φ_{I} and of the quadrature signal φ_{Q}, respectively, is set in the respective other path. In the differential signal detectors DE1, DE2, the optical in-phase and quadrature signals are in each case detected by means of two photodiodes and converted into corresponding electric currents by means of a differential amplifier.

In the electrical evaluation unit AWE there are arranged downstream of the two differential signal detectors DE1, DE2 in series a normalizer NORM, a symbol decision unit SE, a data reconstruction logic DRL and—in the chosen exemplary embodiment, since it is only optional—a multiplexer MUX, which converts the parallel reconstructed data stream back into a serial data stream of data bits again. The parallel amplitude detection path ADP or the electrical output signal thereof is fed both to the normalizer NORM and to the symbol decision unit SE, such that the amplitude information is directly available at both components.

In the normalizer NORM, the normalization—already explained above—of the different phase and amplitude states on to a common constellation circle is carried out (the mathematical operation is represented in the insert in FIG. 1; here Tₛ denotes the symbol duration, I(t) denotes the in-phase signal, Q(t) denotes the quadrature signal and Pₛ(t) denotes the light intensity of the optical data signal Star-M QAM). For the reconstruction of the phase information, the symbol decision unit SE carries out a simple IQ decision (as in the case of DPSK), and determines the amplitude information directly from the signal of the amplitude detection path ADP.

The correspondence of this construction to a homodyne receiver is demonstrated in FIG. 6. The following figures have a construction fundamentally analogous to FIG. 2. Reference symbols not mentioned or indicated there in each case should correspondingly be inferred from FIG. 2 or are explained in connection therewith.

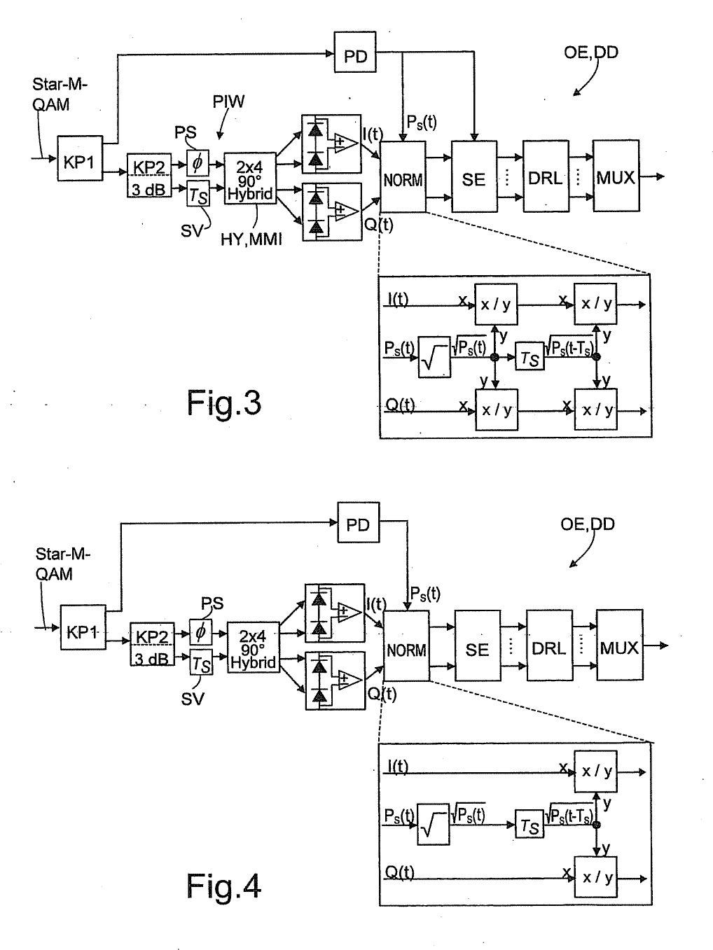

FIG. 3 likewise illustrates an embodiment of the optical receiver OE, according to the invention as a direct receiver DD. In contrast to the embodiment in accordance with FIG. 2, however, the PM-IM converter PIW is embodied as a 2×4-90° hybrid HY with an additional symbol delay unit SV for delay by the symbol duration Tₛ upstream of one of the inputs of the 2×4-90° hybrid HY. The 2×4-90° hybrid HY can be realized as a multimode interference coupler MMI. In the exemplary embodiment shown, it is possible to provide an additional phase shift for rotating the constellation circle as desired. For this purpose, a phase shifter PS is arranged upstream of one of the two inputs of the 2×4-90° hybrid HY. In this case, however, the phase shifter PS should be regarded only as an option.

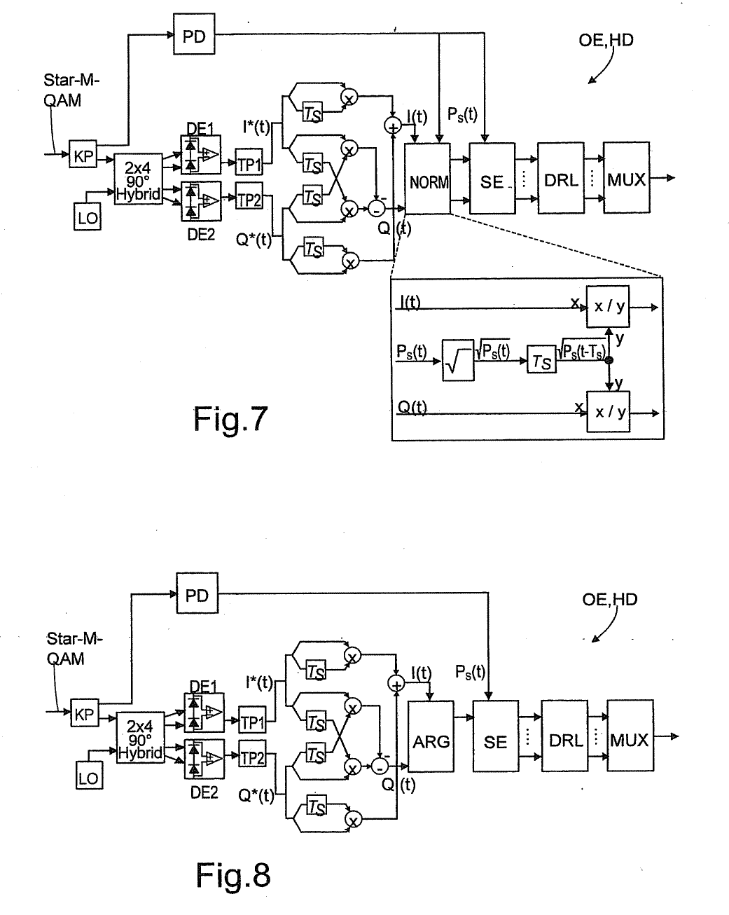

FIG. 4 likewise shows a direct receiver DD in accordance with FIG. 3, but here with a simple normalization. For this purpose, the amplitude detection path ADP is only connected to the normalizer NORM. A simple division only by the amplitude delayed by the symbol duration Tₛ is carried out. Amplitude and phase information items are obtained by means of IQ decision in the symbol decision unit SE on the basis of the reconstructed QAM constellation. The correspondence of this construction to a phase diversity homodyne receiver is demonstrated in FIG. 7.

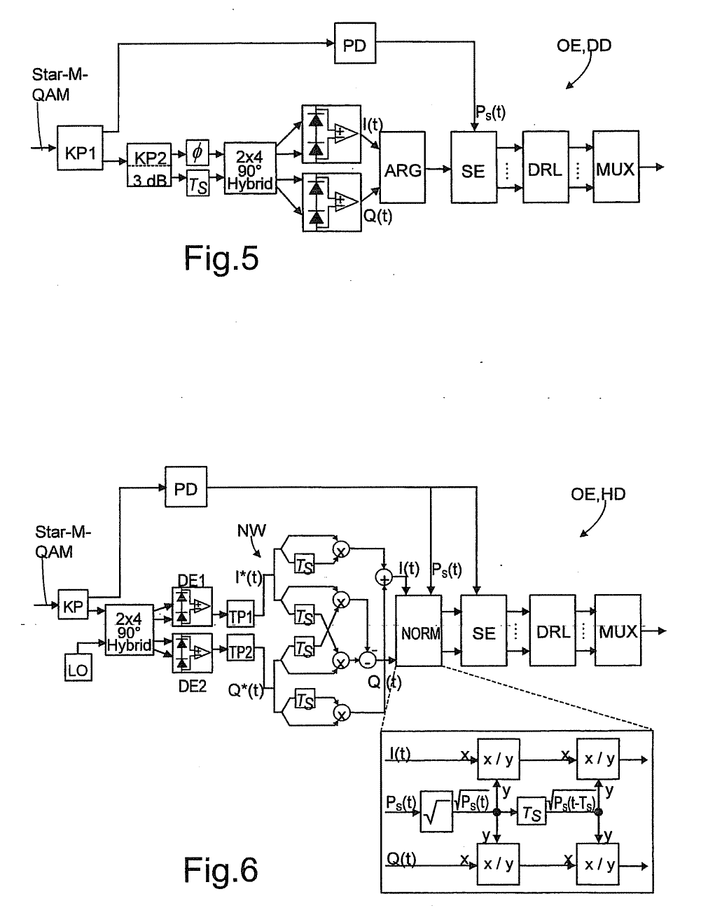

FIG. 5 illustrates a direct receiver DD in accordance with FIG. 3 or 4 wherein the amplitude detection path is lead only to the symbol decision unit SE. The phase detection is effected by means of an ARG operator ARG, wherein the angle between the in-phase signal I(t) as real part and the quadrature signal Q(t) as imaginary part of a complex number is determined. The correspondence of this construction to a homodyne receiver is demonstrated in FIG. 8.

FIGS. 6, 7 and 8 show embodiments corresponding to FIGS. 2, 4 and 5 for a homodyne coherent receiver HD. In this case, the phase detection path PDP is started from a 2×4-90° hybrid HY, to the second input of which a signal from a local oscillator LO is passed. In each case two outputs of the 2×4-90° hybrid HY lead to the in-phase signal path IPS and to the quadrature signal path QS. In each case a differential signal detector DE1, DE2 and thereafter a low-pass filter TP1, TP2 are arranged in both paths. The outputs of the two low-pass filters TP1, TP2 are followed by an electronic network NW for the further processing of the in-phase and quadrature signals I*(t), Q*(t) disturbed by the phase noise, in which the in-phase signal I(t) is obtained by a self-multiplication of the in-phase signal I*(t) and quadrature signal Q*(t) by their copies delayed by the symbol duration Tₛ and a subsequent addition and the quadrature signal Q(t) is obtained by a cross-multiplication of the in-phase signal I*(t) and quadrature signal Q*(t) by their copies delayed by the symbol duration Tₛ and a subsequent subtraction. Depending on the embodiment, the two outputs of the electronic network NW then once again pass to the normalizer NORM (FIGS. 6 and 7) or the ARG operator ARG (FIG. 8). Therefore, in the case of the homodyne coherent receiver HD, too, the fundamental concept according to the invention can be used for the demodulation of M-valued, in particular higher-valued, quadrature amplitude modulation with differential phase coding.

### LIST OF REFERENCE SYMBOLS

ADP Amplitude detection path
ARG ARG operator
AWE Electrical evaluation unit
DD Optical direct receiver
DE Differential signal detector (balanced detector)
DLI Delay interferometer
DRL Data reconstruction logic
HD Homodyne coherent receiver
HY 2×4-90° hybrid
I(t) In-phase signal
I*(t) Received in-phase signal at the HD, disturbed by phase noise
IPS In-phase signal path
KP Optical coupler
LO Local oscillator
MMI Multi-mode interference coupler
MUX Multiplexer
NORM Normalizer
NW Electronic network
OE Optical receiver
PD Photodiode
PDP Phase detection path
PS Phase shifter
PIW PM-IM converter
Q(t) Quadrature signal
Q*(t) Received quadrature signal at the HD, disturbed by phase noise
QS Quadrature signal path
SV Symbol delay unit
TP Low-pass filter
Tₛ Symbol duration
SE Symbol decision unit
Star-M QAM Received data signal with star-shaped QAM modulation

1.-23. (canceled)

24. An optical receiver, comprising:
a first coupler which is adapted to split a received data signal in a first signal path which is intended as an amplitude detection path and a second signal path which is intended as a phase detection path,
a second coupler which is adapted to split the second signal path into a third signal path which is intended as an in-phase signal path for generating in-phase signals and a fourth signal path which is intended as a quadrature signal path for generating quadrature signals,
wherein the first, the third and the fourth signal path are coupled to an evaluation unit,
wherein the evaluation unit comprises a normalizer having at least three inputs and at least one output, wherein the inputs are coupled to the first, the third and the fourth signal path respectively, said normalizer being adapted to normalize the signals provided by the third and the fourth signal path with the aid of signals from the first signal path,
wherein the evaluation unit comprises further a symbol decision unit having at least one input and at least one output, the input of the symbol decision unit being coupled to the output of the normalizer, wherein the symbol decision unit is adapted to make a symbol decision using at least the normalized signals provided by the third and the fourth signal path and optionally additionally from the signal from the first signal path.

25. The optical receiver according to claim 24, wherein the evaluation unit comprises further a data reconstruction logic, having at least one input and at least one output, the input of the data reconstruction logic being coupled to the output of the symbol decision unit.

26. The optical receiver according to claim 24, wherein the first signal path is coupled to both to the normalizer and to the symbol decision unit, wherein the normalizer is adapted to perform a first division of the in-phase and quadrature signals by the present amplitude information of the received data signal, to delay the amplitude information by the symbol duration and perform a second division of the result of the first division by the delayed amplitude information, and
the symbol decision unit is adapted to make the symbol decisions by amplitude decision using the signal from the amplitude detection path and by phase decision from the normalized in-phase and quadrature signals.

27. The optical receiver according to claim 24, wherein the normalizer is adapted to divide the in-phase and quadrature signals only by the amplitude information delayed by the symbol duration and the symbol decision unit is adapted to make the symbol decisions on the basis of the reconstructed QAM constellation.

28. The optical receiver according to claim 24, comprising further a PM-IM converter having two inputs and four outputs, the inputs being coupled to the third and the fourth signal path and the outputs being coupled in pairs to the inputs of two differential signal detectors being arranged in the third signal path and in the fourth signal path respectively.

29. The optical receiver according to claim 28, wherein the PM-IM converter comprises any of two delay line interferometers or one 90°-hybrid having at least two inputs and one symbol delay unit having an input and an output, the output being coupled to one of the two inputs of the 90°-hybrid and the input being coupled to any of the third signal path or the fourth signal path.

30. The optical receiver according to claim 29, comprising further a phase shifter having an input and an output, the input being coupled to any of the third signal path or the fourth signal path, and the output of the phase shifter being coupled to any of an input of the 90°-hybrid or an input of the symbol delay unit.

31. The optical receiver according to claim 24, wherein at least two optical and/or electronic components are arranged on a single semiconductor die.

32. The optical receiver according to claim 24, wherein
the second coupler comprises a 90°-hybrid having two inputs and four outputs, wherein one input is coupled to the second signal path,
a local oscillator having one output and being coupled to one input of the 90°-hybrid,
an arrangement of two respective differential signal detectors each of them being coupled to two outputs of the 90°-hybrid,
an arrangement of an electronic network which is adapted to form the in-phase signal by a self-multiplication of the in-phase signal disturbed by the phase noise and the quadrature signal disturbed by the phase noise by their respective copies, delayed by the symbol duration and a subsequent addition, and wherein
the electronic network is adapted further to form the quadrature signal and by a cross-multiplication of the in-phase signal disturbed by the phase noise and the quadrature signal disturbed by the phase noise by their respective copies delayed by the symbol duration and a subsequent subtraction.

33. The optical receiver according to claim 32, comprising further an automatic frequency control loop which is adapted to correct a frequency offset between the frequency of the local oscillator and the carrier frequency of the received data signal.

34. The optical receiver according to claim 32, comprising further two low-pass filters each having an input and an output, the inputs being coupled to the outputs of the differential signal detectors.

35. The optical receiver according to claim 32, wherein the 90°-hybrid comprises a multi-mode interference coupler.

36. The optical receiver according to claim 32, wherein the second signal path is adapted to provide a polarization independent signal transmission.

37. The optical receiver according to claim 32, wherein a directly detecting photodiode is coupled to the first signal path or an amplitude information is detected by means of a coherent detection method.

38. An optical receiver, comprising
a first coupler which is adapted to split the received data signal in a first signal path which is intended as an amplitude detection path and a second signal path which is intended as a phase detection path,
a second coupler which is adapted to split the second signal path into a third signal path which is intended as an in-phase signal path for generating in-phase signals and a fourth signal path which is intended as a quadrature signal path for generating quadrature signals,
wherein the first, the third and the fourth signal path are coupled to an evaluation unit,
wherein the evaluation unit comprises an ARG operator having at least two inputs and at least one output, wherein the inputs are coupled to the third and the fourth signal path respectively, said ARG operator being adapted to determine an angle,
wherein the evaluation unit comprises further a symbol decision unit having at least two inputs and at least one output, one input of the symbol decision unit being coupled to the output of the ARG operator and one input being coupled to the first signal path, wherein the symbol decision unit is adapted to make a symbol decision using at least the angle provided by the ARG operator and the signal from the first signal path.

39. The optical receiver according to claim 38, wherein the evaluation unit comprises further a data reconstruction logic having at least one input and at least one output, the input of the data reconstruction logic being coupled to the output of the symbol decision unit.

40. The optical receiver according to claim 38, comprising further a PM-IM converter having two inputs and four outputs, the inputs being coupled to the third and the fourth signal path and the outputs being coupled in pairs to the inputs of two differential signal detectors being arranged in the third signal path and in the fourth signal path respectively.

41. The optical receiver according to claim 40, wherein the PM-IM converter comprises any of two delay line interferometers or one 90°-hybrid having at least two inputs and one symbol delay unit having an input and an output, the output being coupled to one of the two inputs of the 90°-hybrid and the input being coupled to any of the third signal path or the fourth signal path.

42. The optical receiver according to claim 41, comprising further a phase shifter having an input and an output, the input being coupled to any of the third signal path or the fourth signal path, and the output of the phase shifter being coupled to any of an input of the 90°-hybrid or an input of the symbol delay unit.

43. The optical receiver according to claim 38, wherein
the second coupler comprises a 90°-hybrid having two inputs and four outputs, wherein one input is coupled to the second signal path,
a local oscillator having one output and being coupled to one input of the 90°-hybrid,
an arrangement of two respective differential signal detectors each of them being coupled to two outputs of the 90°-hybrid,
an arrangement of an electronic network which is adapted to form the in-phase signal by a self-multiplication of the in-phase signal disturbed by the phase noise and the quadrature signal disturbed by the phase noise by their respective copies, delayed by the symbol duration and a subsequent addition, and wherein
the electronic network is adapted further to form the quadrature signal and by a cross-multiplication of the in-phase signal disturbed by the phase noise and the quadrature signal disturbed by the phase noise by their respective copies delayed by the symbol duration and a subsequent subtraction.

44. The optical receiver according to claim 43, comprising further an automatic frequency control loop which is adapted to correct a frequency offset between the frequency of the local oscillator and the carrier frequency of the received data signal.

45. The optical receiver according to claim 43, comprising further two low-pass filters each having an input and an output, the inputs being coupled to the outputs of the differential signal detectors.

46. The optical receiver according to claim 43, wherein the 90°-hybrid comprises a multi-mode interference coupler.

47. The optical receiver according to claim 38, wherein at least two optical and/or electronic components are arranged on a single semiconductor die.

48. The optical receiver according to claim 38, wherein the second signal path is adapted to provide a polarization independent signal transmission.

49. A method for receiving an optical data signal comprising the following steps:
splitting a received data signal in a first signal path which is intended as an amplitude detection path and a second signal path which is intended as a phase detection path,
splitting the second signal path into a third signal path which is intended as an in-phase signal path for generating in-phase signals and a fourth signal path which is intended as a quadrature signal path for generating quadrature signals,
normalizing the signals provided by the third and the fourth signal path with the aid of signals from the first signal path,
making a symbol decision using at least the normalized signals provided by the third and the fourth signal path and optionally additionally from the signal from the first signal path.

50. The method according to claim 49, wherein the in-phase and quadrature signals are normalized by first dividing the in-phase and quadrature signals by the present amplitude information of the received data signal, delaying the amplitude information by the symbol duration, and dividing the result of the first division by the delayed amplitude information, and the symbol decisions are made by amplitude decision using the signal from the first signal path and by phase decision from the normalized in-phase/quadrature signals.

51. The method according to claim 49, wherein the in-phase and quadrature signals are divided only by the amplitude information delayed by the symbol duration and the symbol decisions are made on the basis of the reconstructed QAM constellation.

52. The method according to claim 49, wherein the phase modulation of the in-phase signal is converted to an intensity modulation which is detected by at least one photo diode, and wherein the phase modulation of the quadrature signal is converted to an intensity modulation which is detected by at least one photo diode.

53. A method for receiving an optical data signal comprising the following steps:
splitting the received data signal in a first signal path which is intended as an amplitude detection path and a second signal path which is intended as a phase detection path,
splitting the second signal path into a third signal path which is intended as an in-phase signal path for generating in-phase signals and a fourth signal path which is intended as a quadrature signal path for generating quadrature signals,
determine an angle from the in-phase signals and the quadrature signals,
making a symbol decision using at least the angle determined from the in-phase signals and the quadrature signals and the signal from the first signal path.
